(19) United States
(12) Patent Application Publication
(10) Pub. No.: US 2024/0367695 A1
(43) Pub. Date: Nov. 7, 2024

(54) A MAGNETIC TRANSPORT LINE DRIVING SYSTEM, A MAGNETIC TRANSPORT LINE, AND A MAGNETIC TRANSPORT LINE DRIVING METHOD

(71) Applicant: AGILEBOT ROBOTICS CO., LTD., SHANGHAI (CN)

(72) Inventors: Jin QIAN, SHANGHAI (CN); Ruiqin LI, SHANGHAI (CN); Qichao WANG, SHANGHAI (CN); Yuejin HU, SHANGHAI (CN)

(73) Assignee: AGILEBOT ROBOTICS CO., LTD., SHANGHAI (CN)

(21) Appl. No.: 18/688,787

(22) PCT Filed: Jul. 27, 2022
(86) PCT No.: PCT/CN2022/108201

§ 371 Date: Mar. 3, 2024

(30) Foreign Application Priority Data
Sep. 2, 2021 (CN) 202111025731.8

(51) Int. Cl. B61B 13/12

(52) U.S. Cl. CPC B61B 13/12

(57) ABSTRACT

The present disclosure provides a magnetic transport line driving system, a magnetic transport line, and a control method for a magnetic transport line driving system, driving an actuating mechanism of a magnetic transport line according to an instruction, the actuating mechanism including multiple motor stators and at least one motor mover. The magnetic transport line driving system includes a motion control unit, configured for generating a driving instruction according to an instruction; multiple position sensing units, of which the number corresponds to that of motor stators, configured for detecting quantity information and position information of motor movers; a motor control unit, calculates quantity information and address information of effective shaft according to the driving instruction, and the quantity information and position information of the motor movers, generating a motor stator selection instruction for selecting a specified motor stator, and generating an inversion setting instruction for generating a specified driving current.

### FIELD

The present disclosure is in the field of automatic transport lines, particularly magnetic transport line driving systems, and more particularly relates to a magnetic transport line driving system, a magnetic transport line, and a magnetic transport line driving method.

### BACKGROUND OF THE DISCLOSURE

With the continuous development of manufacturing technology, automatic transport line technology is widely applied in automated production lines in various industries including manufacturing, packaging, assembly, and printing. Over time, it has given rise to various forms of transport lines. Among them, magnetic transport lines, compared to traditional transport solutions such as belt transport lines, roller transport lines, and chain transport lines, stand out due to their non-contact transport mode, allowing for higher transport speeds and system flexibility.

Magnetic transport lines typically include an actuating mechanism that operates under the drive of the driving system and a driving system to achieve automatic transport. In existing magnetic transport lines, the predominant actuating mechanism utilized is the linear motor, where the motor mover is composed of a coil (relatively short), and the motor stator (relatively long) is composed of alternately arranged permanent magnets. Due to the nature of linear motors in these solutions, the motor mover needs to be powered through wires supplying the coils, requiring trailing cables. This limitation poses practical challenges in practical applications. Consequently, the industry has also developed an actuating mechanism configuration consisting of coil stators and permanent magnet movers, each motor stator contains a UVW three-phase windings, which are connected in a Y-shaped configuration, similar to traditional three-phase servo motors, with discontinuity between the motors.

As shown in FIG. 1, the prior art magnetic transport line includes an actuating mechanism 100 and a driving system 200. The actuating mechanism 100 typically includes multiple motor stators 110 and at least one motor mover 120. The driving system 200 typically includes multiple motor driving units 230 and a motion control unit 210. The motor driving unit 230 corresponds to each motor stator 110 and generates a suitable magnetic field to drive the motor mover moved according to the position of the motor mover 120. The motor driving unit 230 employs a servo driver, from the perspective of traditional servo motors, the motor driving unit and the corresponding motor stator constitute a complete motor, also referred to as a motor shaft. The motion control unit 210 sends position and speed instruction to the servo motor driving unit based on the received instruction. In other embodiments, position sensing (not shown in the figure) may be further included, usually a grating ruler or a magnetic grating ruler, for detecting the position of each mover on the transport line.

In magnetic transport lines, the number of motor shafts is usually particularly large, while the number of motor movers is limited. As shown in FIG. 2, when the corresponding motor stator 110 in the actuating mechanism 100 does not have any motor mover 120 passing through, the motor stator 110 does not affect the movement of the motor mover 120, and no calculation or communication is required. At this time, the corresponding motor shaft is called the ineffective shaft 112, and vice versa called the effective shaft 111. As the motor mover 120 moves, the states of the effective and ineffective shafts of the motor stator 110 are dynamically changing. At the same time, within the actuating mechanism, the proportion of ineffective shafts is very high

This also leads to the unsatisfactory performance of existing magnetic transport line schemes in practical applications, mainly due to the following issues:

1. In a magnetic transport line, the size of an individual motor cannot be particularly large, and the distance cannot be too extensive, otherwise the accuracy will be reduced. In practice, existing magnetic transport lines typically require 12 or more motors per meter, and to enable independent movement of motor movers within the magnetic transport system, each motor requires an independent servo driver. Therefore, the existing design requires a large number of servo driving units, making the overall circuit of the magnetic transport lines complex and leading to high system costs.

2. To generate an appropriate magnetic field to drive the movement of motor movers, the servo driving unit needs to receive information such as the position, speed, acceleration, etc. of the motor mover. Through calculation, it then outputs the corresponding shaft for driving. Therefore, the servo driving units typically undertake major functions such as communication, calculation, waveform generation, and power driving. Additionally, due to the high hardware requirements for real-time calculation and communication of motor information, existing designs often employ high-performance DSPs or large-capacity FPGAs to reduce system latency and enhance response speed, further increasing the overall system costs.

### SUMMARY OF THE DISCLOSURE

Due to the aforementioned problems in the practical application of the magnetic transport line driving system in the existing solution, the present disclosure aims to provide a magnetic transport line drive system and a method thereof to address the above-mentioned problems in the existing solutions, to reduce system latency, improving response speed, decreasing the complexity of the driving system wiring, and under the condition of effectively controlling hardware requirements and costs of the magnetic transport line driving system, the system structure has been simplified, and the efficiency and reliability of the system have been improved.

The embodiments of the magnetic transport line driving system in present disclosure includes

A magnetic transport line driving system, configured for driving an actuating mechanism of a magnetic transport line according to an instruction, the actuating mechanism including multiple motor stators and at least one motor mover, the magnetic transport line driving system includes
a motion control unit, configured for generating a driving instruction according to an instruction;
multiple position sensing units, of which the number corresponds to that of motor stators, configured for detecting quantity information and position information of motor movers;
a motor control unit, configured for calculating quantity information and address information of effective shafts according to the driving instruction, the quantity information and position information of the motor movers, generating a motor stator selection instruction for selecting a specified motor stator, and generating an inversion setting instruction for generating a specified driving current;
and multiple motor driving units, of which the number corresponds to that of the motor stators, configured for generating and providing a driving current to the corresponding motor stator according to the motor stator selection instruction and the inversion setting instruction.

In one embodiment, the motor driving unit includes
a driving communication module, configured for transmitting data between the motor driving unit and the outside;
a waveform generation module, configured for generating an inversion control waveform according to the inversion setting instruction; and
a power driving inversion module, generating and providing driving current for the specified motor stator according to the inversion control waveform.

In one embodiment, the motor driving unit further includes a collection module, configured for collecting current information, voltage information, and temperature information of each phase in the motor stator, and feedback to the motor control unit.

In one embodiment, the motor driving unit further includes
a fault processing module, which determines whether there is a fault that affects the operation of the magnetic transport line based on the speed information and position information of the motor mover in the magnetic transport line, as well as the current information of each phase of the motor stator, and outputting a shutdown instruction to the power driving inversion module when the fault occurs.

In one embodiment, the motor control unit includes
a first communication module, configured for transmitting data between the motor control unit and the motor driving unit, and/or the position sensing unit;
a second communication module, configured for transmitting data between the motor control unit and the motion control unit;
an effective shaft management module, configured for calculating the quantity information and address information of the effective shafts according to the quantity information and position information of the motor movers, and generating the motor stator selection instruction; and
at least one motor computing module, configured for generating and outputting the inversion setting instruction to the motor driving unit according to the driving instruction, the motor stator selection instruction, and the current information of each phase in the motor stator.

In one embodiment, the motor control unit further includes
a computing resource scheduling and allocating module, configured for selecting one or more motor computing modules according to the motor stator selection instruction, and the selected motor computing module completes the calculation;
a preservation and distribution module, configured for preserving and distributing the calculation result to the first communication module.

In one embodiment, the motion control unit includes
a program execution module, configured for generating the driving instruction according to the instruction; and
a collision detection module, configured for determining whether the driving instruction will cause a collision of the motor movers, wherein the determination result is negative, the driving instruction is output to the motor control unit, and wherein the determination result is positive, it waits until the determination result is negative before outputting the driving instruction.

In one embodiment, multiple loops formed by connecting multiple position sensing units in series in parallel, as well as multiple loops formed by connecting multiple motor driving units in series in parallel in the magnetic transport line driving system.

In one embodiment, the magnetic transport line driving system further includes
a swapping control unit, configured for transmitting data between the motor control unit and the position sensing unit, and/or the motor driving unit on each loop based on the motor stator selection instruction

The present disclosure also provides a magnetic transport line, which includes an actuating mechanism, includes multiple motor stators, and at least one motor mover, and the magnetic transport line further includes a magnetic transport line driving system as claimed in any one of the preceding claims.

The present disclosure also provides a control method for a magnetic transport line driving system, controlled based on the effective shaft, configured to drive the actuating mechanism of the magnetic transport line according to the instruction, the actuating mechanism includes multiple motor stators and at least one motor mover, and the control method includes
driving instruction generating step, generating driving instruction according to the instruction;
motor mover detection step, acquiring quantity information, position information of the motor mover;
effective shaft address calculation step, calculating quantity information and address information of effective shafts based on the quantity information and position information of the motor mover;
motor stator selection step, generating a motor stator selection instruction according to the address information of effective shafts;
control loop calculation step, calculating the position loop, the speed loop, and the current loop, respectively, based on the position information of the motor mover, the phase current information of the motor stator, and the inversion setting instruction of the previous cycle, to generate an inversion setting instruction.
driving current generation step, storing the inversion setting instruction, selecting the corresponding motor stator according to the motor stator selection instruction, and generating the driving current for the motor stator; and
repeating the above steps to form a closed-loop control of the motor mover.

In one embodiment, the control method further includes
collision detection step, determining whether the driving instruction will cause a collision of the motor movers, in case the result of the determination is negative, the driving instruction is outputted, and wherein the determination result is positive, it waits until the determination result is negative before outputting the driving instruction.

In one embodiment, the control method further includes
computing resource scheduling step, allocating the required computing resource for the control loop calculation step based on the motor stator selection instruction.

By applying the magnetic transport line driving system, the magnetic transport line, and the magnetic transport line driving method provided by the present disclosure, it is possible to address the problems existing in the current technology from the source and bring the following embodiments:

Firstly, the magnetic transport line driving system, the magnetic transport line, and the magnetic transport line driving method provided by the present disclosure simplify the largest number of motor driving units on a large scale by centralizing calculations in the motor control unit, to greatly reduce costs;

Secondly, the magnetic transport line driving system, the magnetic transport line, and the magnetic transport line driving method provided by the present disclosure achieve centralized computation by concentrating calculations in the motor control unit. This eliminates the need for complex calculations in the motor driving unit, significantly reducing the number of chips and other electronic components required for the unit, which simultaneously reduces costs while leading to an improvement in reliability.

Thirdly, the magnetic transport line driving system, the magnetic transport line, and the magnetic transport line driving method provided by the present disclosure enhance system scalability without introducing latency in the system by incorporating a computing resource scheduling and allocating module, as well as a swapping control unit, ensuring that the communication latency from the motor control unit to each motor driving unit is less than the control cycle and supporting multiple loops.

For those familiar with the field of the disclosure, after reviewing the following sections in conjunction with the drawings, these and other embodiments will become more apparent.

### DESCRIPTION OF DRAWINGS

The above disclosure content and embodiment of the present disclosure will be better understood in conjunction with the accompanying drawings. It should be noted that the accompanying drawings are only examples of the claimed disclosure. In the drawings, the same reference numerals represent identical or similar elements.

FIG. 1 is a schematic structural diagram of the magnetic transport line driving system in the prior art.

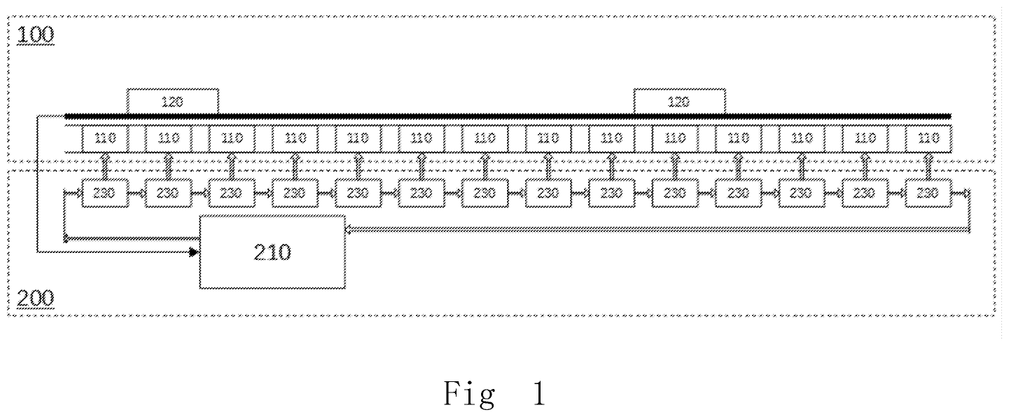

FIG. 2 is a schematic diagram of the effective shaft and the ineffective shaft of the magnetic transport line driving system.

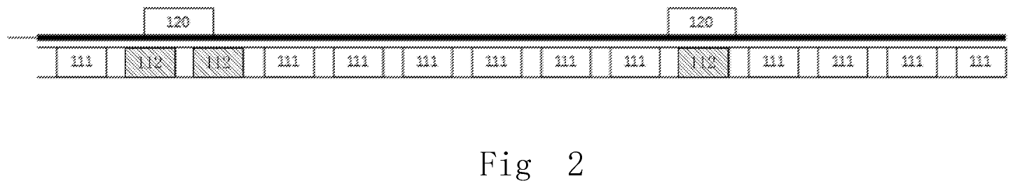

FIG. 3 is a schematic structural diagram of a magnetic transport line driving system of an embodiment in the present disclosure.

FIG. 4 is a schematic structural diagram of a motor driving unit of an embodiment of the magnetic transport line driving system in the present disclosure.

FIG. 5 is a schematic structural diagram of a motor control unit of an embodiment of the magnetic transport line driving system in the present disclosure.

FIG. 6 is a schematic structural diagram of a motion control unit of an embodiment of the magnetic transport line driving system in the present disclosure.

FIG. 7 is a schematic diagram of a partial structure of an embodiment of the magnetic transport line driving system in the present disclosure.

FIG. 8 is a schematic flowchart of an embodiment of a control method of the magnetic transport line driving system in the present disclosure.

The reference signs are as follows:
100. actuating mechanism
110. motor stator
111. effective shaft
111. ineffective shaft
120. motor mover
200. driving system
210. motion control unit
211. program execution module
212. collision detection module
213. motor stator management module
220. motor control unit
221. first communication module
222. second communication module
223. effective shaft management module
224. motor computing module
225. computing resource scheduling and allocating module
226. preservation and distribution module
230. motor driving unit
231. driving communication module
232. waveform generation module
233. power driving inversion module
234. collection module
235. fault processing module
236. power management module
240. position sensing unit
250. swapping control unit

### DETAILED DESCRIPTION OF THE EMBODIMENTS

The detailed embodiments of the present disclosure are described in detail in the embodiment methods below, the contents of which are sufficient to understand and practice the teachings of the present disclosure. Moreover, based on the disclosure in the specification, the claims, and the accompanying drawings of the present disclosure.

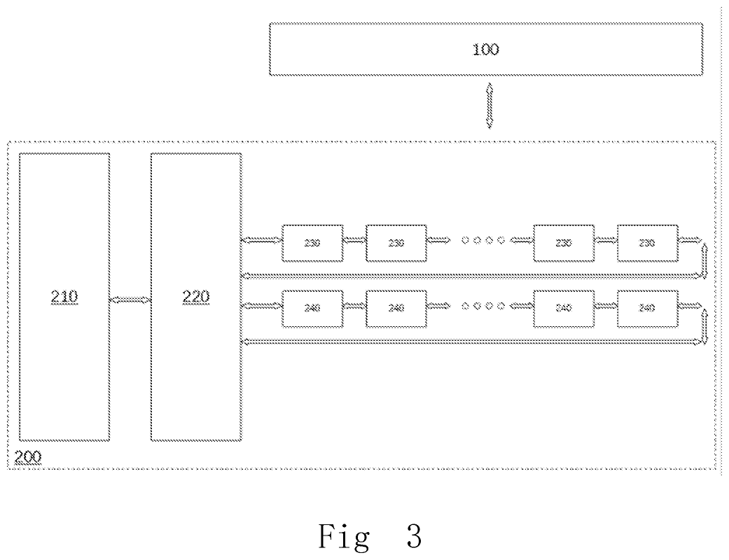

FIG. 3 to 6 illustrate some embodiments of the magnetic transport line driving system in the present disclosure.

Therein, FIG. 3 illustrates a block schematic diagram of the magnetic transport line driving system in the present disclosure.

A magnetic transport line driving system 200 is provided for driving an actuating mechanism 100 of the magnetic transport line according to the instruction, the magnetic transport line driving system includes

A motion control unit 210 generates driving instruction based on the instruction.

Multiple position sensing units 240, which correspond to the number of the motor stator 110, for detecting the quantity information and position information of the motor mover 120. In one embodiment, the position sensing units can be a grating ruler or a magnetic grating ruler.

A motor control unit 220 calculates the quantity information and position information of the effective shaft based on the driving instruction and the quantity and position information of the motor mover 120, generates the motor stator selection instruction for selecting the specified motor stator 110, and the inversion setting instruction for generating the specified driving current; and
multiple motor driving units 230, corresponding to the number of motor stator 110, generate and provide driving current to the corresponding motor stator 110 based on the motor stator selection instruction and inversion setting instruction.

In the whole system, the structure of the motor driving unit 230 with the largest quantity is significantly simplified and costs are greatly reduced by centralizing the scheduling and execution of calculation tasks in the motor control unit.

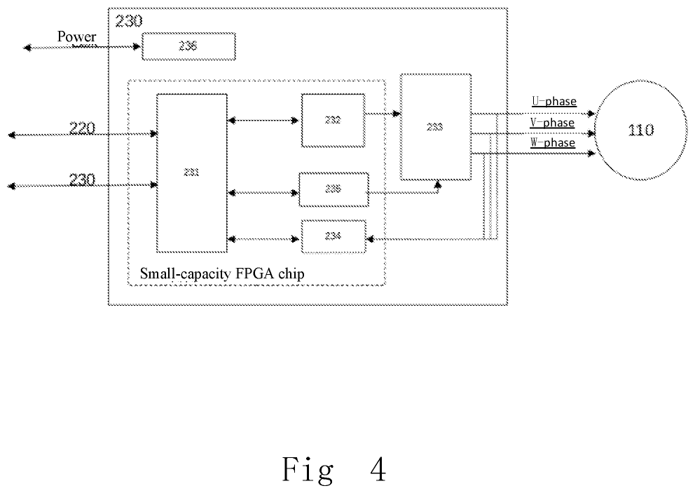

FIG. 4 illustrates a schematic structural diagram of a motor driving unit 230 of an embodiment of the magnetic transport line driving system in the present disclosure, including

A drive communication module 231, for transmitting data between the motor driving unit 230 and the outside.

In one embodiment, data transmission includes data transmission between multiple motor driving unit 230 and data transmission between the motor driving unit 230 and the motor control unit 220. In one embodiment, data transmission occurs bidirectionally through Ethernet communication and may also utilize other means such as optical fiber.

In one embodiment, the ports of the drive communication module 231 can be configured with one or more network ports or optical ports, enabling multiple motor driving units 230 to be connected in series by forming mutual interconnections.

Since the communication of the drive communication module 231 only includes input: 1) inversion setting 2) system control, output: 1) current and state feedback. The communication cycle is set to the calculation cycle of the current loop, which, in one embodiment, is 50 microseconds. Therefore, the communication format of the motor driving unit is simple, and the intervals are very short, contributing to enhanced system reliability and fault detection characteristics.

The waveform generation module 232 generates an inversion control waveform based on inversion setting instruction. In one embodiment, the inversion control waveform is SPWM waveform.

The power driving inversion module 233 generates and provides driving current to the specified motor stator 110 based on the inversion control waveform.

In one embodiment, the motor driving unit 230 further includes a collection module 234 for collecting current information, voltage information, and temperature information of each phase in the motor stator 110 and providing feedback to the motor control unit 220.

In one embodiment, the motor driving unit 230 further includes a fault processing module 235, which determines whether there is a fault that affects the operation of the magnetic transport line based on the speed information, position information of the motor mover, and the current information of each phase of the motor stator in the magnetic transport line, such as over-deviation faults. In the event of a fault, the fault processing module issues a shutdown instruction to the power driving inversion module 233.

In one embodiment, the motor driving unit 230 further includes a power management module 236 for managing all power supplies within the motor driving unit 230, including internal modules and power driving power.

In one embodiment, the drive communication module 231, waveform generation module 232, collection module 234, and fault processing module 235 can be integrated into one main control chip. In one embodiment, the main control chip is a small-capacity FPGA chip.

In one embodiment, multiple motor driving units 230 can be integrated onto a single PCB board, and the cost and system complexity can be further reduced by sharing the power management module 236 and the drive communication module 231.

Due to the absence of complex calculations, the motor driving unit in the present disclosure does not require the use of expensive DSP and large-capacity FPGA in existing solutions. The number of chips and other electronic components is also significantly reduced, resulting in both cost reduction and increased reliability.

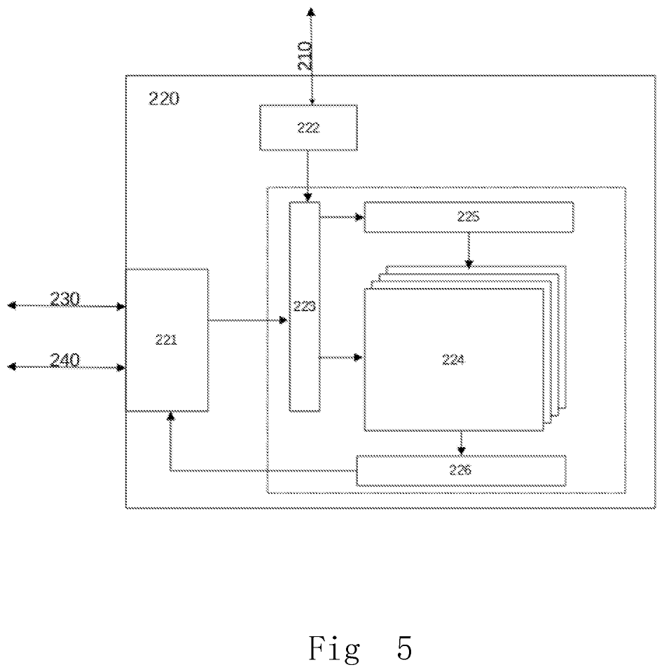

FIG. 5 illustrates a schematic structural diagram of a motor control unit 220 of an embodiment of the magnetic transport line driving system in the present disclosure, including a first communication module 221 for transmitting data between the motor control unit 220 and the motor driving unit 230 and/or the position sensing unit 240;

a second communication module 222 for transmitting data between the motor control unit 220 and the motion control unit 210;

an effective shaft management module 223 calculates the quantity information and position information of the effective shaft based on the quantity information and position information of the motor mover 120 provided by the position sensing unit 240, and generates motor stator selection instruction;

At least one motor computing module 224 generates and outputs an inversion setting instruction to the motor driving unit 230 based on the driving instruction, motor stator selection instruction, and the current information of each phase in the motor stator 110 provided by the motor driving unit 230.

In one embodiment, the motor computing module 224 can also perform compensation calculations for the disturbance of the magnetic transport line, such as static friction force, dynamic friction force, cogging force, and the like. In one embodiment, the motor control unit 220 further includes

A computing resource scheduling and allocating module 225 selects one or more motor computing modules 224 based on the motor stator selection instruction and the selected motor computing module 224 completes the calculation; by employing the computing resource scheduling and allocating module 225, time-division multiplexing of the motor computing module 224 can be achieved. For example, One control cycle can accomplish calculations for 16 effective shafts.

A preservation and distribution module 226 preserves and distributes the calculation results to the first communication module 221.

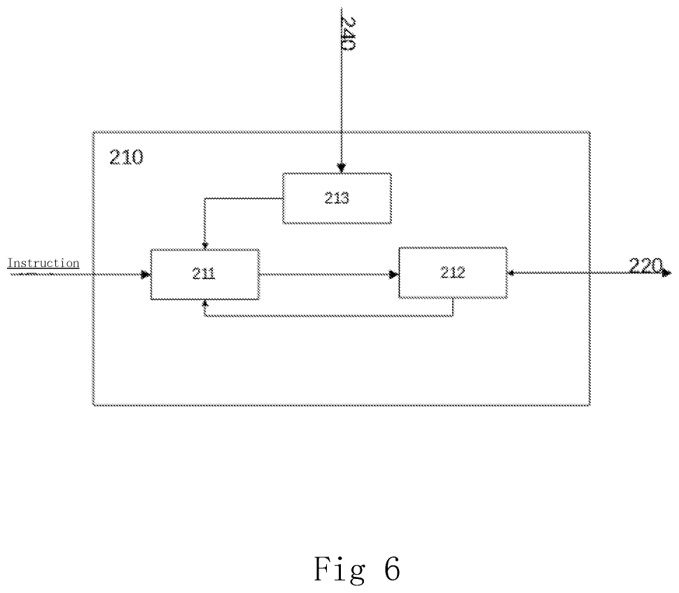

FIG. 6 illustrates a schematic structural diagram of a motion control unit 210 of an embodiment of the magnetic transport line driving system in the present disclosure, including

A program execution module 211 for generating driving instruction based on the instruction. In one embodiment, the instruction may be a program instruction output from a user or other upper-level device.

A collision detection module 212 for determining whether the driving instruction will cause a collision of the motor movers 120 based on the driving instruction and the position information of the motor mover 120 reported by the motor control unit 220, wherein the determination result is negative, the driving instruction is output to the motor control unit, and wherein the determination result is positive, it waits until the determination result is negative before outputting the driving instruction.

In one embodiment, the motion control unit 210 further includes

A motor stator management module 213 for managing the motor stator 110 of the system. When external motor stators are added, they provide feedback to the program execution module, allocate resources, and instruct programs accordingly. Similarly, when internal motor stators exit the system, it offers feedback to the program execution module, facilitating the recovery and reallocation of resource and program instruction.

In one embodiment, the motion control unit 210 and the motor control unit 220 can be integrated into one controller.

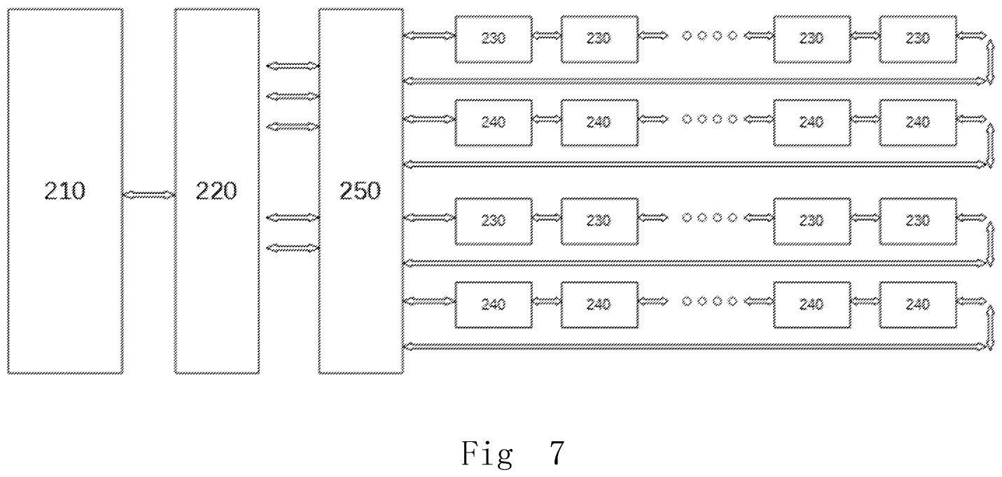

FIG. 7 illustrates another embodiment of the magnetic transport line driving system in the present disclosure,

Among them, each motor driving unit 230 and position sensor 240 include a superior communication port and a subordinate communication port (Ethernet or optical fiber), which form a loop. The motor control unit 220 sends communication packets with enumeration instruction through the upper-level communication port, initiating the enumeration of addresses. The first motor driving unit 230/position sensor 240 has the address 1, the next one is 2, and so forth. This continues until the last motor driving unit 230/position sensor 240 is reached, at which point the information is returned to the motor control unit 220.

Due to frequent communication in this system, the communication cycle must be shorter than the control cycle. In the case of a series connection forming a loop, each passage of a data packet through one motor driving unit introduces a delay. To avoid an excessively large absolute delay, when the number of motor shafts is significant, for instance, exceeding 80 motor shafts, several loops can be added. This ensures that the communication delay from the motor driving unit 230 and position sensor 240 to each motor is less than the control cycle, according to another embodiment of the present disclosure.

In one embodiment, all loops in the system require unified addressing, and the addresses on each loop are continuous. The address ranges of different loops are different, and each loop, that is, the address of each motor shaft on the system, is unique. For example:

| Loop sequence number | Address range |
|---|---|
| Loop 1 | 1-80 |
| Loop 2 | 81-160 |
| Loop 3 | 161-240 |

If there are too many loops, according to another embodiment of the present disclosure, the magnetic transport line driving system may also include
a swapping control unit 250 for transmitting data between the motor control unit 220 and the position sensing unit 240 and/or the motor driving unit 230 on each loop based on motor stator selection instruction. The swapping control unit 250 recognizes the address information of the packet header and sends the packet to the corresponding motor driving unit 230 and position sensor 240 on the loop. The data packets returned by the corresponding loop can also be returned to the motor control unit 220 through the fastest channel.

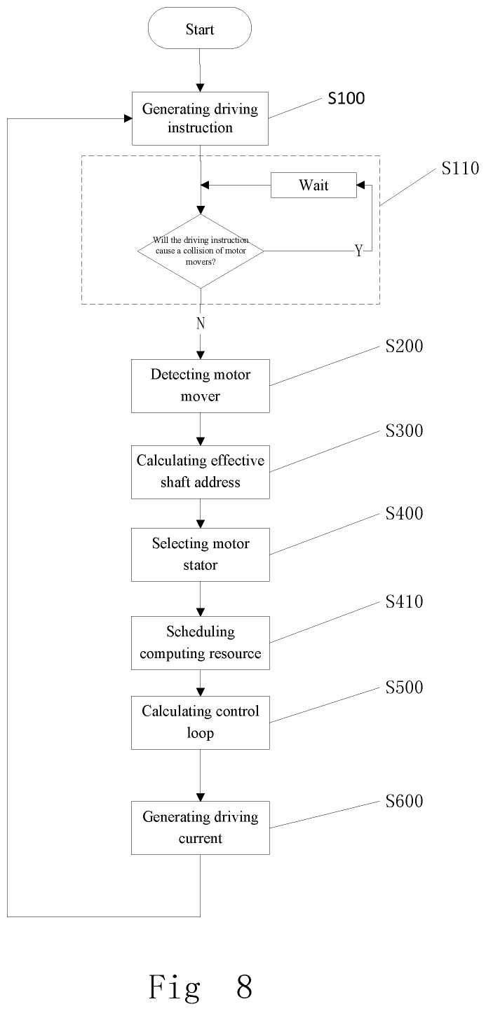

FIG. 8 illustrates a schematic flowchart of a control method of the magnetic transport line driving system in the present disclosure.

The control methods include
step S100, the drive instruction generation step, the motion control unit 210 generates driving instruction based on user or other external instructions.

In one embodiment, step S100 further includes step S110, the collision detection step, the motion control unit 210 determining whether the driving instruction will cause a collision of the motor movers, wherein the determination result is negative, the driving instruction is outputted, and wherein the determination result is positive, it waits until the determination result is negative before outputting the driving instruction.

Step S200, the motor mover detection step, the position sensing unit 240 obtains the quantity information and position information of the motor mover.

Step S300, effective shaft address calculation step, motor control unit 220 calculates the quantity information and address information of effective shafts based on the quantity information and position information of the motor mover.

Step S400, motor stator selection step, the motor control unit 220 generates a motor stator selection instruction based on the address information of the effective shaft;

In one embodiment, step S400 further includes step S410, the computing resource scheduling step, the motor control unit 220 allocates required computing resource for the control loop calculation step based on motor stator selection instruction.

Step S500, the control loop calculation step, the motor control unit 220 completes the calculation of the position loop, speed loop, and current loop respectively based on the position information of the motor mover, the current information of each phase of the motor stator, and the inversion setting instruction of the previous cycle. Subsequently, it generates the inversion setting instruction.

In one embodiment, in the calculation of the position loop, speed loop, and current loop mentioned above, the outermost loop is the position loop, which receives position instruction, compensation, and position feedback, and outputs speed instruction; The middle is the speed loop, which receives speed instruction, compensation, and speed feedback from the position loop, and outputs current instruction; and the innermost is the current loop, which uses FOC (Field Oriented Control) control to receive current instruction, compensation, and current feedback, ultimately providing the inversion instruction directly.

Step S600, driving current generation step, the motor control unit 220 stores the inversion setting instruction and selects the corresponding motor stator according to the motor stator selection instruction. The corresponding motor driving unit 230 generates the driving current for the motor stator.

In one embodiment, the motor driving unit 230 simultaneously feeds back the actual motor current to the current loop, and the angular displacement or linear position generated by the motor rotation is fed back to the speed loop and position loop.

Repeating the above steps to form a closed-loop control of the motor mover to achieve precise position and speed control.

Embodiments of the magnetic transport line provided by the present disclosure include

A magnetic transport line with a length of 5 meters, consists of 16 motor shafts per meter, with three movers moving reciprocally along the magnetic transport line. Therefore, the actuating mechanism of the magnetic transport line includes 80 motor stators and 3 motor movers, with a maximum effective shaft count of 10, approximately 12.5% of the total shaft count.

The driving system includes
1) 80 magnetic position sensors
2) 80 motor driving units

In one embodiment, each motor driving unit includes a drive communication module, a waveform generation module, a power driving inversion module, and a collection module. All related control functions can be completed using a small-capacity FPGA (9K equivalent logic unit).

Every 4 motor driving units are integrated into one motor drive board, with a total of 20 motor drive boards.
3) One integrated drive control motion controller, each motion controller integrates one motion control unit and one motor control unit.

In one embodiment, the motion control unit includes a program execution module; The motor control unit includes a first communication module, a second communication module, an effective shaft management module, a motor computing module, a computing resource scheduling and allocating module, and a preservation and distribution module.

The operation control steps of the driving system adopt closed-loop control, as follows:

During power-on initialization, the system defaults to no motor mover present.

The program execution module generates driving instruction.

The magnetic position sensor periodically detects the position of the motor mover and transmits it to the motor control unit through the first communication module.

The collection module periodically detects the current of the motor stator and transmits it to the motor control unit through the first communication module.

After obtaining relevant information (position, speed, current), the effective shaft management module calculates the position of three effective shafts of the motor and forms a motor stator selection instruction.

The computing resource scheduling and allocating module allocates the effective shaft calculation of the mover to the corresponding computing resource.

Control-related calculations (including position loop, speed loop, and current loop) are completed by the motor computing module, and the results are output to the preservation and distribution module.

The preservation and distribution module preserves the results of this test and outputs them to the motor driving unit in sequence according to the address.

The data packets are sequentially transmitted to the corresponding address of the motor driving unit and enter the power driving inversion module, generating the corresponding three-phase current.

Repeating the previous process to achieve a closed-loop control effect on the motor mover.

From the above embodiments, it can be seen that the magnetic transport line driving system, magnetic transport line, and the control methods of the magnetic transport line driving system provided by the present disclosure can solve the problems existing in the prior art from the source; by concentrating the computation in the motor control unit, the largest number of motor driving units is significantly simplified, leading to substantial cost reductions; By eliminating the need for complex calculations in the motor driving unit, the number of chips and other electronic components required for the unit itself is greatly reduced, to enhance reliability while reducing costs; enhancing system scalability without introducing delay in the system by incorporating a computing resource scheduling and allocating module as well as a swapping control unit, ensuring that the communication latency from the motor control unit to each motor driving unit is less than the control cycle and supporting multiple loops.

The terms and expressions used here are employed for descriptive purposes, and the present disclosure should not be limited to these terms and expressions. The use of these terms and expressions does not imply the exclusion of any equivalent features of the concepts and descriptions (or portions thereof). It should be recognized that various modifications may be included within the scope of the claims. Other modifications, changes, and substitutions are also possible. Accordingly, the claims should be construed to encompass all such equivalents.

1. A magnetic transport line driving system, configured for driving an actuating mechanism of a magnetic transport line according to an instruction, the actuating mechanism comprising multiple motor stators and at least one motor mover,
wherein the magnetic transport line driving system comprises:
a motion control unit, configured for generating a driving instruction according to the instruction;
multiple position sensing units, of which the number corresponds to that of motor stators, configured for detecting quantity information and position information of motor movers;
a motor control unit, configured for calculating quantity information and address information of effective shafts according to the driving instruction, the quantity information and position information of the motor movers, generating a motor stator selection instruction for selecting a specified motor stator, and generating an inversion setting instruction for generating a specified driving current; and
multiple motor driving units, of which the number corresponds to that of the motor stators, configured for generating and providing a driving current to the corresponding motor stator according to the motor stator selection instruction and the inversion setting instruction.

2. The magnetic transport line driving system as claimed in claim 1, wherein the motor driving unit comprises:
a driving communication module, configured for transmitting data between the motor driving unit and the outside;
a waveform generation module, configured for generating an inversion control waveform according to the inversion setting instruction; and
a power driving inversion module, generating and providing driving current for the specified motor stator according to the inversion control waveform.

3. The magnetic transport line driving system as claimed in claim 2, wherein the motor driving unit further comprises:
a collection module, configured for collecting current information, voltage information, and temperature information of each phase in the motor stator, and feedback to the motor control unit.

4. The magnetic transport line driving system as claimed in claim 2, wherein the motor driving unit further comprises:
a fault processing module, which determines whether there is a fault that affects the operation of the magnetic transport line based on speed information and position information of the motor mover, wherein current information of each phase of the motor stator in the magnetic transport line, and outputting a shutdown instruction to the power driving inversion module when the fault occurs.

5. The magnetic transport line driving system of claim 1, wherein the motor control unit further comprises:
a first communication module, configured for transmitting data between the motor control unit and the motor driving unit, and/or the position sensing unit;
a second communication module, configured for transmitting data between the motor control unit and the motion control unit;
an effective shaft management module, configured for calculating the quantity information and address information of the effective shafts according to the quantity information and position information of the motor movers, and generating the motor stator selection instruction; and
at least one motor computing module, configured for generating and outputting the inversion setting instruction to the motor driving unit according to the driving instruction, the motor stator selection instruction, and the current information of each phase in the motor stator.

6. The magnetic transport line driving system as claimed in claim 5, wherein the motor control unit further comprises:
a computing resource scheduling and allocating module, configured for selecting one or more motor computing modules according to the motor stator selection instruction, and the selected motor computing module completes the calculation; and
a preservation and distribution module, configured for preserving and distributing the calculation result to the first communication module.

7. The magnetic transport line driving system of claim 1, wherein the motion control unit comprises:
a program execution module, configured for generating the driving instruction according to the instruction; and
a collision detection module, configured for determining whether the driving instruction causes a collision of the motor movers, wherein the determination result is negative, the driving instruction is output to the motor control unit, and wherein the determination result is positive, it waits until the determination result is negative before outputting the driving instruction.

8. The magnetic transport line driving system of claim 1, wherein, the magnetic transport line driving system comprises multiple loops which
formed by connecting multiple position sensing units in series in parallel, and multiple loops which formed by connecting multiple motor driving units in series in parallel.

9. The magnetic transport line driving system as claimed in claim 8, wherein the magnetic transport line driving system further comprises:
a swapping control unit, configured for transmitting data between the motor control unit and the position sensing unit, and/or the motor driving unit on each loop according to the motor stator selection instruction

10. A magnetic transport line, comprises an actuating mechanism, which includes multiple motor stators and at least one motor mover, wherein the magnetic transport line further comprises a magnetic transport line driving system of claim 1.

11. A control method for a magnetic transport line driving system, which is controlled based on the effective shaft, configured for driving an actuating mechanism of the magnetic transport line according to the instruction, the actuating mechanism comprises multiple motor stators and at least one motor mover,
wherein the control method comprises:
driving instruction generating step, generating driving instruction according to the instruction;
motor mover detection step, acquiring quantity information, position information of the motor mover;
effective shaft address calculation step, calculating quantity information and address information of effective shafts according to the quantity information and position information of the motor mover;
motor stator selection step, generating a motor stator selection instruction according to the address information of the effective shaft;
control loop calculation step, calculating the position loop, the speed loop, and the current loop, respectively, based on the position information of the motor mover, current information of each phase of the motor stator, and the inversion setting instruction of the previous cycle, and generating an inversion setting instruction;
driving current generation step, storing the inversion setting instruction, selecting the corresponding motor stator according to the motor stator selection instruction, and generating the driving current for the motor stator; and
repeating the above steps to form a closed-loop control of the motor mover.

12. The control method of the magnetic transport line driving system as claimed in claim 11, wherein the control method further comprises:
collision detection step after the driving instruction generating step, determining whether the driving instruction causes a collision of the motor movers, in case the result of the determination is negative, the driving instruction is outputted, wherein the determination result is positive, it waits until the determination result is negative before outputting the driving instruction.

13. The control method of the magnetic transport line driving system as claimed in claim 12, wherein the control method further comprises:
computing resource scheduling step after the motor stator selection step, allocating the required computing resource for the control loop calculation step according to the motor stator selection instruction.
